(19) United States
(12) Patent Application Publication
(10) Pub. No.: US 2016/0063263 A1
(43) Pub. Date: Mar. 3, 2016

(54) DATA STORAGE SYSTEM WITH INFORMATION SECURITY PROTECTION

(71) Applicant: Apacer Technology Inc., New Taipei City (TW)

(72) Inventors: Jiunn-Chang Lee, New Taipei City (TW); Cheng-Hsiung Liao, New Taipei City (TW)

(21) Appl. No.: 14/468,815

(22) Filed: Aug. 26, 2014

(51) Int. Cl. G06F 21/62; G06F 21/79

(52) U.S. Cl. CPC G06F 21/62; G06F 21/79

(57) ABSTRACT

A data storage system with information security protection includes an SSD and at least one activation device selectively connected to the SSD. The SSD has a device identifier, and includes a data storage unit and a controlling and processing unit. The controlling and processing unit is in information connection with the data storage unit, and is written with at least one set of firmware data that is triggered and activated by an activation key to execute a predetermined task on the data storage unit. The activation device includes a data processing unit which is written with the activation key in advance, and has a pairing mode and an enabling mode. In the pairing mode, the data processing unit accesses and stores the device identifier. In the enabling mode, the data processing unit compares the stored device identifier to output the activation key to the controlling and processing unit.

### FIELD OF THE INVENTION

The present invention relates to a data storage system, and particularly to a data storage system with information security protection.

### BACKGROUND OF THE INVENTION

With extensive applications of various types of information apparatuses, more and more users computerize important data such as reports and documentation and store the computerized data into all kinds of information apparatuses for easy operations. Current information apparatuses mainly employ hard disk drives (HDDs) to store data. However, a common HDD is not designed with information security protection. Thus, having activated the information apparatus, an illegal user can arbitrarily access the data stored in the HDD, including reading, writing and duplicating, leading to undesired leakage of important data.

Therefore, manufacturers in the technical field of HDDs constantly thrive in improving information protection. For example, the Taiwan Patent No. 1382316 discloses a “Cascaded Combination Structure of Flash Disks to Create Security Function”. The cascaded combination structure includes a plurality of data disks and a key disk. At least one of the data disks is divided into a public zone and a private zone. The private zone can only be accessed when a public program stored in the key disk is executed in an operating system. Although the above disclosure utilizes the key disk as a condition for accessing the private zone and achieves information security protection, the above approach of dividing the data disk into the public zone and the private zone and constantly hiding the private zone from the operating system undoubtedly reduces a data storage capacity of the data disk. Further, in the above disclosure, as the data stored in the private zone can only be accessed through executing the public program stored in the key disk, not only application inconveniences are caused but also an effect of hierarchical protection cannot be provided. Accordingly, a solution is required to improve the above issues.

### SUMMARY OF THE INVENTION

It is a primary object of the present invention to provide a data storage system that can be applied to solid state drive (SSD) without involving other software programs.

To achieve the above object, a data storage system with information security protection is provided. The data storage system includes an SSD and at least one activation device. The SSD has a device identifier, and includes a data storage unit, a controlling and processing unit, a data transmission interface and a device connection port. The controlling and processing unit is in information connection with the data storage unit, and is written with at least one set of firmware data, which is triggered and activated by an activation key and determines to execute a predetermined task on the data storage unit. The data transmission interface is in information connection with the controlling and processing unit, and receives data transmitted from an information device. The device connection port is in information connection with the controlling and processing unit. The activation unit may be selectively connected to the device connection port, and includes a data processing unit having the activation key written therein in advance. The data processing unit has a pairing mode and an enabling mode. In the pairing mode, the data processing unit establishes a first information connection with the controlling and processing unit via the device connection port, and accesses and stores the device identifier. In the enabling mode, the data processing unit further establishes the information connection with the controlling and processing unit via the device connection port, and compares the recorded device identifier to output the activation key to the controlling and processing unit.

In one embodiment, the device connection port and the activation device use an universal serial bus (USB) transmission specification, and the activation device establishes the information connection with the controlling and processing unit to transmit the activation key by a pair of transmitting/receiving differential signal ends D+ and D−.

In one embodiment, the SSD further includes a data connection line. The data connection line is in information connection with the controlling and processing unit and is assembled with to the activation device to transmit the device identifier and the activation key.

In one embodiment, the controlling and processing unit is written with plurality of sets of firmware data. The activation key required by each set of firmware data for activation is different from that of another.

In one embodiment, the data storage unit may be selected from a group consisting of a single-layer cell (SLC) NAND flash, a multi-layer cell (MLC) NAND flash and a triple-layer cell (TLC) NAND flash.

In one embodiment, the predetermined task may be selected from a group consisting of a data write preventing task, a data deleting task, a data storage unit destructing task and a data write encrypting task.

In one embodiment, the SSD further includes a circuit board and a hard disk casing. The circuit board carries the information storage unit, the controlling and processing unit, the data transmission interface and the device connection port. The hard disk casing accommodates the circuit board, and includes an assembly hole corresponding to the device connection port.

With the structure set forth, the present invention offers features below compared to the prior art.

First of all, in the present invention, sectors of the SSD are not divided or restricted from read and write operations. Thus, users can fully utilize the data storage capacity provided by the SSD.

Secondly, in the present invention, the data storage system writes at least one set of firmware data for executing the predetermined task in the controlling and processing unit, and the activation key of the set of firmware data for activation is different from that of another set of firmware data, thereby achieving an effect of hierarchical information security protection. Further, without involving other software programs, the firmware data can immediately prompt the controlling and processing unit to execute the predetermined task given the activation key and the device identifier are confirmed.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of a data storage system with information security protection according to an embodiment of the present invention;

FIG. 2 is a block diagram of a data storage system with information security protection according to an embodiment of the present invention;

FIG. 3 is a partial schematic diagram of an activation device of a data storage system with information security protection according to another embodiment of the present invention;

FIG. 4 is a flowchart of a process of a data storage system with information security protection according to an embodiment of the present invention; and

FIG. 5 is a schematic diagram of a data storage system with information security protection according to another embodiment of the present invention.

### DETAILED DESCRIPTION OF THE PREFERRED EMBODIMENTS

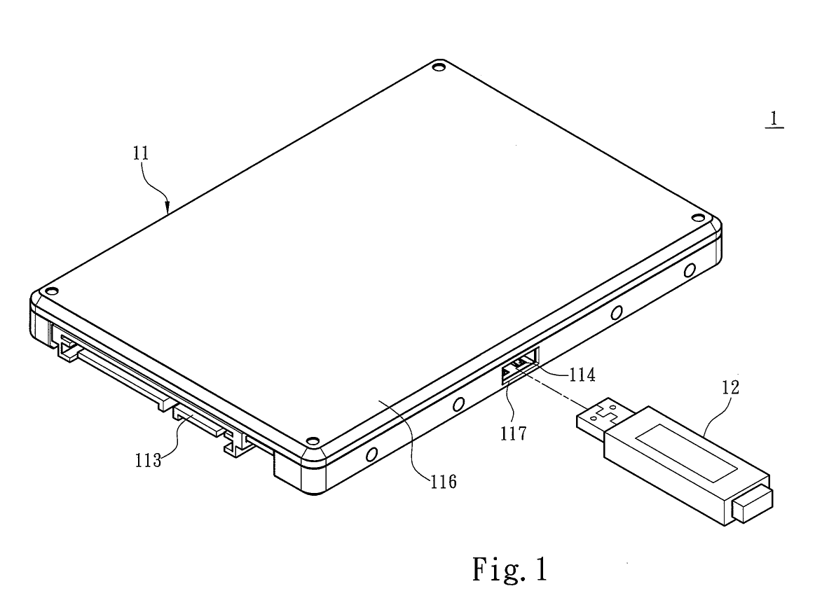

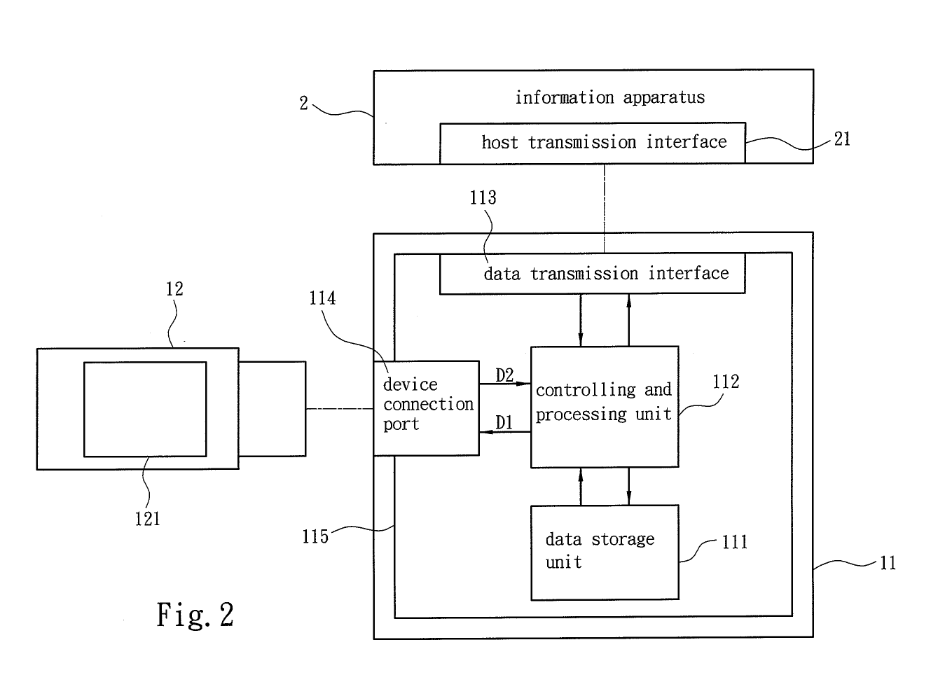

Referring to FIG. 1 and FIG. 2, a data storage system 1 with information security protection is applied in an information apparatus 2. The data storage system 1 may be formed by a solid state disk (SSD) 11 and an activation device 12. The SSD 11 has a device identifier D1, which enables the information apparatus 2 to directly identify a connected device. That is to say, for the information apparatus 2, the device identifier D1 represents the SSD 11. Further, the device identifier of the SSD 11 is different from that of another SSD. The SSD 11 includes a data storage unit 111, a controlling and processing unit 112 in information connection with the data storage unit 111, a data transmission interface 113 in information connection with the controlling and processing unit 112, and a device connection port 114 in information connection with the controlling and processing unit 112.

More specifically, the data storage unit 111 is mainly for storing data received from the information apparatus 2, or for the information apparatus 2 to read the data stored in the data storage unit 111. The data storage unit 111 may be selected from a group consisting of a single-layer cell (SLC) NAND flash, a multi-layer cell (MLC) NAND flash and a triple-layer cell (TLC) NAND flash. Via the data transmission interface 113, the controlling and processing unit 112 receives a read command or a write command that the information apparatus 2 issues to the SSD 11, so as to control the data storage unit 111 to read or write corresponding data. In the present invention, the controlling and processing unit 112 further is written with at least one set of firmware data, which is triggered and activated by an activation key D2 and determines to execute a predetermined task on the data storage unit 111. More specifically, the controlling and processing unit 111 of the present invention may be an integrated circuit, and is burned with at least one set of firmware data during the manufacturing process of the SSD 11. The predetermined task executed by each set of firmware data is different from that of another, and the activation key D2 required by each set of firmware data is also different from that of another. Further, the data transmission interface 113 is mainly for establishing an information connection with a host transmission interface 21 of the information apparatus 2, and may be implemented by the Serial Advanced Technology Attachment (SATA) specification. Further, the device connection port 114 of the present invention may be implemented by the USB specification. More specifically, the SSD 11 of the present invention further includes a circuit board 115 and a hard disk casing 116. The circuit board 115 carries the data storage unit 111, the controlling and processing unit 112, the data transmission interface 113 and the device connection port 114. The hard disk casing 116 accommodates the circuit board 115, and includes an assembly hole 117 corresponding to the device connection port 114. A position of the assembly hole 117 may be correspondingly adjusted according to a position of the device connection port 114 on the circuit board 115.

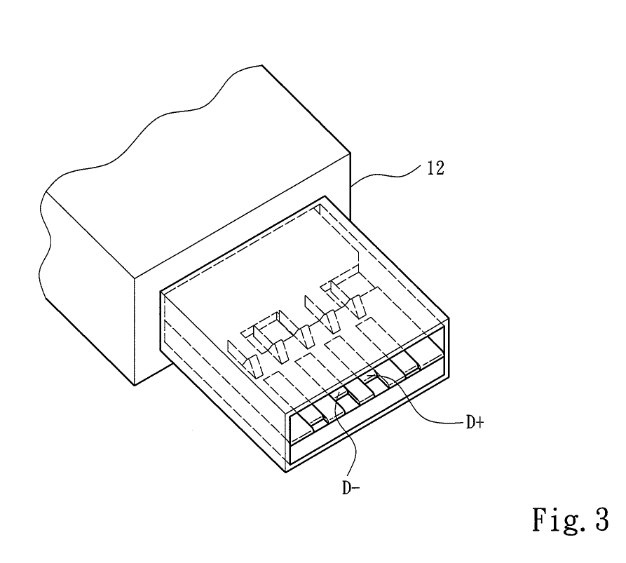

In one embodiment of the present invention, the activation device 12 may be implemented by an externally connected hot-plug storage device, and may be selectively connected to the device connection port 114. The activation device 12 includes a data processing unit 121, which is written with the activation key D2 in advance. Further, the data processing unit 121 has a pairing mode and an enabling mode. In the pairing mode, the data processing unit 121 establishes a first information connection with the controlling and processing unit 112 via the device connection port 114, and accesses and stores the device identifier D1. In the enabling mode, the data processing unit 121 establishes the information connection with the controlling and processing unit 112 again via the device port 114, and compares the stored device identifier D1 to output the activation key D2 to the controlling and processing unit 112. The data processing unit 121 may also be implemented by an integrated circuit. Further, the activation key D2 that is written in advance and stored in the data processing unit 121 may be written therein by data burning during the manufacturing process of the activation device 12, with modification and removal of the activation key D2 designed as restricted. Thus, after manufacturing the activation device 12 of the present invention, only one single activation key D2 is present for activating the firmware data that has the same activation key D2 as an activation condition. Further, known from the above description, the activation device 12 may be implemented by an externally connected hot-plug storage device. In one embodiment, the activation device 12 may be implemented by the USB transmission specification as the device connection port 114, as shown in FIG. 1 and FIG. 3. Further, the activation device 12 may establish the information connection with the controlling and processing unit 112 to transmit the activation key D2 by a pair of transmitting/receiving differential signal ends D+ and D−. Further, the activation device 12 may be implemented by the USB3.0 transmission specification.

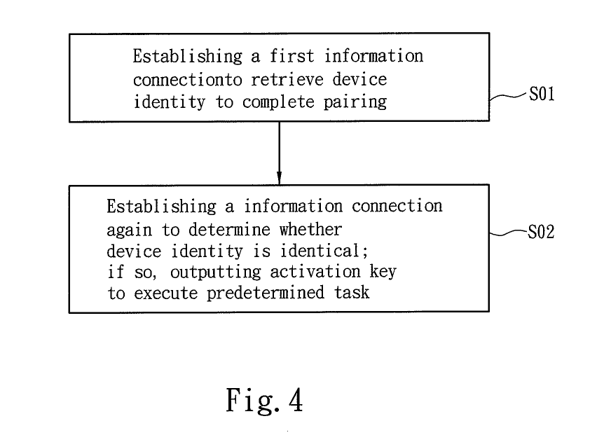

An application process of the data storage system with information security protection of the present invention is described in detail with reference to FIG. 1 to FIG. 4 below. At the beginning of the application process of the data storage system with information security protection 1 of the present invention, at least one set of firmware data is written into the controlling and processing unit 112 in the SSD 11. In the embodiment, for example, at least a first set of firmware data and a second set of firmware data is written into the controlling and processing unit 112. The predetermined task executed by the first set of firmware data is a data write preventing task, and the predetermined task of the second set of firmware data is a data storage unit destructing task. Further, in the embodiment, in default, the activation key D2 for activating the first set of firmware data is written into the data processing unit 121 of the activation device 12. While the SSD 11 and the activation device 12 are connected to each other for the first time, the device identifier D1 of the SSD 11 is accessed and stored in the data processing unit 121 (as step S01). Thus, the activation device 12 can only be paired and used with the SSD 11 and cannot be applied to another SSD 11. The user may later disengage the activation device 12 from the SSD 11. To execute the predetermined task stored in the firmware data, the activation device 12 is again connected to the SSD 11. For the re-connection, the data processing unit 121 first compares whether the device identifier D1 accessed from the SSD 11 is identical to the device identifier D1 in the data processing unit 121. If so, the data processing unit 121 outputs the activation key D2 to the controlling and processing unit 112 of the SSD. After receiving the activation key D2, the controlling and processing unit 112 determines the firmware data that can be activated by the activation key D2. In the embodiment, assume that the activation key D2 is for activating the first set of firmware data. While the controlling and processing unit 112 determines that the activation key D2 is identical to the activation key D2 required for activating the first set of firmware data, the controlling and processing unit 112 executes the data write preventing task to prohibit the information apparatus 2 from writing data into the data storage unit 111 (as step S02). Accordingly, in an application of the present invention, the activation device 12 may be plural, and each activation device 12 can only activate one set of the plurality of sets of firmware data stored in the controlling and processing unit 112.

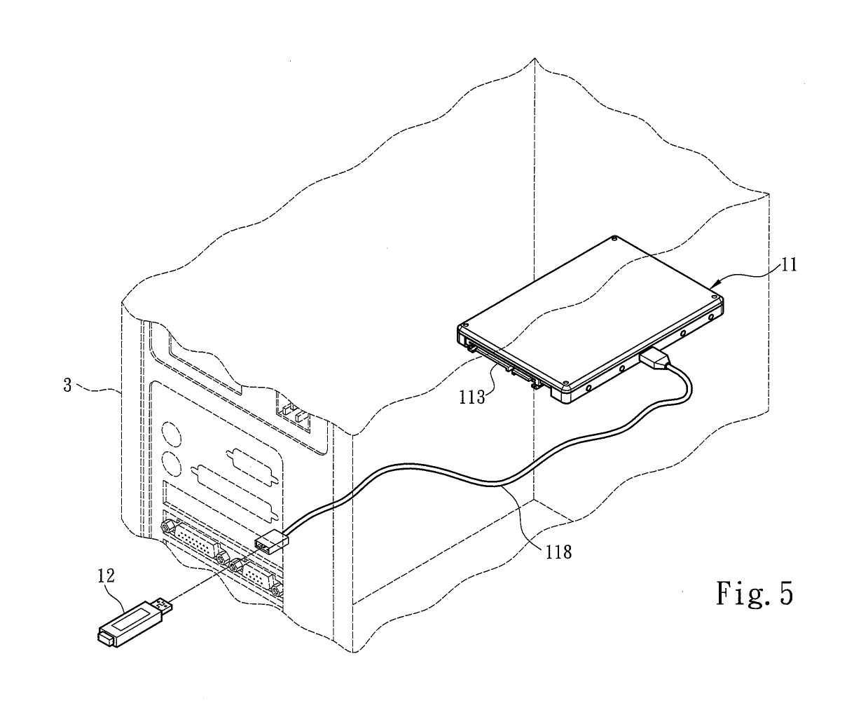

Referring to FIG. 5, in one embodiment, the SSD 11 further includes a data connection line 118. The data connection line 118 is in information connection with the controlling and processing unit 112 and is assembled with to the activation device 12 to transmit the device identifier D1 and the activation key D2. More specifically, one end of the data connection line 117 may be assembled with to the device connection port 114 and the other end may be fixed to a computer housing 3. As such, the user may selectively assemble the activation device 12 to the data connection line 118.

In conclusion, a data storage system with information security protection includes an SSD and at least activation device selectively connected to the SSD. The SSD includes a data storage unit and a controlling and processing unit. The controlling and processing unit is in information connection with the data storage unit, and is written with at least one set of firmware data, which is triggered and activated by an activation key and determines to execute a predetermined task on the data storage unit. The activation unit includes a data processing unit having the activation key written therein in advance. The data processing unit has a pairing mode and an enabling mode. In the pairing mode, the data processing unit establishes a first information connection with the controlling and processing unit via the device connection port, and accesses and stores the device identifier. In the enabling mode, the data processing unit further establishes the information connection with the controlling and processing unit via the device connection port, and compares the recorded device identifier to output the activation key to the controlling and processing unit. Accordingly, the data storage system with information security protection can be applied to the SSD without involving computer software.

What is claimed is:

1. A data storage system with information security protection, comprising:
a solid state drive (SSD), having a device identifier, comprising:
a data storage unit;
a controlling and processing unit, in information connection with the data storage unit, written with at least one set of firmware data that is triggered and activated by an activation key to execute a predetermined task on the data storage unit;
a data transmission interface, in information connection with the controlling and processing unit, configured to receive data transmitted from an information device; and
a device connection port, in information connection with the controlling and processing unit; and
at least one activation device, selectively connected to the device connection port, comprising a data processing unit which is written with the activation key in advance, having a pairing mode and an enabling mode;
wherein in the pairing mode the data processing unit establishes a first information connection with the controlling and processing unit via the device connection port to access and store the device identifier, while in the enabling mode the data processing unit establishes the information connection with the controlling and processing unit again via the device connection port to compare the stored device identifier to output the activation key to the controlling and processing unit.

2. The data storage system with information security protection of claim 1, wherein the device connection port and the activation device use an universal serial bus (USB) transmission specification, and the activation device establishes the information connection with the controlling and processing unit to transmit the activation key by a pair of transmitting/receiving differential signal ends D+ and D−.

3. The data storage system with information security protection of claim 2, wherein the SSD further comprises:
a data connection line, in information connection with the controlling and processing unit, for assembling with the activation device to transmit the device identifier and the activation key.

4. The data storage system with information security protection of claim 1, wherein the SSD further comprises:
a data connection line, in information connection with the controlling and processing unit, for assembling with the activation device to transmit the device identifier and the activation key.

5. The data storage system with information security protection of claim 1, wherein the controlling and processing unit is written with a plurality of sets of firmware data, and the activation key that each set of firmware data requires for activation is different from that of another.

6. The data storage system with information security protection of claim 1, wherein the data storage unit is selected from a group consisting of a single-layer cell (SLC) NAND flash, a multi-layer cell (MLC) NAND flash and a triple-layer cell (TLC) NAND flash.

7. The data storage system with information security protection of claim 1, wherein the predetermined task is selected from a group consisting of a data write preventing task, a data deleting task, a data storage unit destructing task and a data write encrypting task.

8. The data storage system with information security protection of claim 1, wherein the SSD further comprises:
a circuit board, carrying the data storage unit, the controlling and processing unit, the data transmission interface and the device connection port; and
a hard disk casing, accommodating the circuit board, including an assembly hole corresponding to the device connection port.
